(19) United States
(12) Patent Application Publication
(10) Pub. No.: US 2017/0190500 A1
(43) Pub. Date: Jul. 6, 2017

(54) COOKING DEVICE AND METHOD

(71) Applicant: Christophe De Poly, Le Chesnay (FR)

(72) Inventor: Christophe De Poly, Le Chesnay (FR)

(21) Appl. No.: 15/319,978

(22) PCT Filed: Jun. 19, 2015
(86) PCT No.: PCT/FR2015/051625

§ 371 Date: Feb. 14, 2017

(30) Foreign Application Priority Data
Jun. 24, 2014 (FR) 1455840

(51) Int. Cl. B65D 81/34; A47J 27/00; A47J 27/10; A47J 27/18; G01K 11/12; B65D 81/20

(52) U.S. Cl. CPC B65D 81/3415; G01K 11/12; B65D 81/20; A47J 27/10; A47J 27/18; A47J 27/00

(57) ABSTRACT

A method for cooking a food product under vacuum at low temperature includes placing a food product under vacuum in a sealed device and heating the product placed in the sealed device by submerging it in a bath in order to reach a target temperature of between 45° C. and 65° C., wherein the device comprises at least one thermochromic indicator configured to change color and/or appearance at the target temperature, and wherein the temperature of the bath is gradually raised from an initial temperature of at least 20° C. below the target temperature. A device for cooking a food product includes an envelope configured to contain the food product under vacuum and at least one thermochromic indicator in contact with the envelope.

### CROSS-REFERENCE TO RELATED APPLICATIONS

This application is a national phase entry under 35 U.S.C. §371 of International Patent Application PCT/FR2015/051625, filed Jun. 19, 2015, designating the United States of America and published as International Patent Publication WO 2015/197950 A1 on Dec. 30, 2015, which claims the benefit under Article 8 of the Patent Cooperation Treaty to French Patent Application Serial No. 1455840, filed Jun. 24, 2014.

### TECHNICAL FIELD

The present description relates to a device and a method for cooking a food product and, more specifically, the field of low-temperature cooking under vacuum.

### BACKGROUND

In France, low-temperature cooking under vacuum experienced a revival in the 70s under the leadership of great chefs who tried to re-evaluate food cooking temperatures to reach perfect cooking temperatures preserving the integrity and the flavor of the products.

Today, perfect-temperature cooking is a standard in the greatest kitchens in the world and the gourmets have long appreciated the unsurpassed textures and subtle aromas obtained by the greatest chefs with perfect-temperature cooking.

The persons skilled in the art recognize that cooking under vacuum, and low-temperature cooking under vacuum are qualifications that exactly refer to the same cooking mode but are different from the low-temperature cooking obtained, for example, by extending the cooking time of a food product in an oven and by lowering temperatures. This cooking technique is often referred to in the art by the French term “Sous-vide,” which means “under vacuum.”

Such a cooking mode has several advantages:
no risk of overcooking,
preservation of all the nutritive qualities, texture and flavors of the food,
perfect and homogeneous cooking from the outside to the center of the food,
minimum loss of weight in the food since there is no evaporation: only a 5% loss is noted against 20%-30% with a traditional cooking mode (baking, pan frying, etc.).

This new cooking technique requires complete mastery of the temperature in the cooking enclosure and of the temperature at the center of the products, within one degree in some instances.

When cooking at low temperature, the product surface and center cooking is balanced, and the food is cooked evenly. As a matter of fact, water is an excellent heat conductor as opposed to air. The pouch under vacuum eliminates the presence of air, a poor heat conductor, and the pouch is cooked in water, an excellent conductor; everything is provided for a uniform and perfect cooking.

Sealed in the vacuum pouch, the food is cooked in its own juice and no evaporation of aromas or liquids occurs, as no evaporation is possible. Everything is kept within the food; its taste is thus perfectly respected and the concentration of flavors is surprising.

However, it is known that low-temperature cooking (e.g., at a temperature of about 54° C. (about 130° F.) is sufficient to make food fit to eat, but involves a risk of microbial growth within the product. As a matter of fact, cooking temperatures are lower than pasteurization temperatures. Conversely, temperatures required for pasteurization cause the loss of all the previously mentioned benefits of low-temperature vacuum cooking.

Such microbial growth is, however, not a problem for food products that are cooked just before eating, with no delay between preparation and eating. Low-temperature vacuum cooking is intended for basically different applications of vacuum pasteurization methods.

Perfect-temperature cooking is the result of a cooking time/bath temperature coupled with the goal of reaching an internal temperature, the result of which is an even cooking of the food product. Depending upon the food products, the cooking temperature is generally in a range from 55° C. to 65° C. (about 130° F. to about 150° F.).

The usual technique used by a person skilled in the art for achieving a perfect cooking temperature consists in placing a food product to be cooked in a vacuum package, which is then immersed in a constant temperature water bath for a period enabling the food product to reach the bath temperature.

More particularly, placing the food in a vacuum pouch using a vacuum packing machine and then cooking it in a water bath, the temperature of which can be controlled within one degree, is known. As such cooking takes place at much lower temperatures (usually around 55° C. to 65° C. (about 130° F. to about 150° F.) for meat and fish), it requires a longer but controlled time.

The sensitivity of the cooking relative to the bath temperature is relatively high, since a 2° C. (about 3.6° F.) deviation of the bath temperature may affect cooking and, for example, change “medium” to “well done.” Perfect-temperature cooking thus makes it necessary to maintain a precise temperature in the cooking bath, and in the current state of the art, this function is fulfilled by a circulator.

The circulator known in the prior art is a device dedicated to maintaining the temperature bath constant and comprises the following elements: a heat source (resistor), a heat input control element, usually of the PID (proportional integral derivative) type, and a water circulation mechanism to ensure temperature uniformity despite the bath heating discrete point.

For example, the International Patent Publication WO 2013/067825 describes a low-temperature vacuum cooker comprising a body provided with a container and a heating and circulation system. The container comprises a water bowl and a lid. The heating and circulation system includes a heating element, a water pump and connecting tubes. In the low-temperature vacuum cooker, the temperature of water throughout the container is uniform. The heating and circulation circuit makes it possible to heat the circulation water and enables the water, which flows rapidly through the heating element, to absorb over 95% of the thermal energy of the heating element, which saves energy.

European Patent EP2475290 describes a vacuum cooker comprising a cooking enclosure, a heating system, and a housing that accommodates the cooking enclosure and the heating system. The cooking enclosure includes an enclosure body, a multi-function lid, a passive water circulator and, optionally, a rack to hold the food product while cooking.

U.S. Pat. No. 5,097,759 describes another known exemplary vacuum heating device that preferably includes at least two water heating enclosures, with each enclosure being provided with a heater and a thermostat to control the temperature of water in the enclosure. A stirring mechanism is provided to circulate water in each enclosure. Each enclosure is divided into a plurality of sub-enclosures, with each sub-enclosure being provided with an associated timer intended to measure the time elapsed within the sub-enclosure. The device may include a plate storage area and the heating mechanism, and has a work space for preparing the food products to be vacuum cooked and then served to a consumer.

Considering the investments required to achieve perfect-temperature cooking, this technique is still confined to the professional world and is unusual in private home kitchens.

In a domestic environment, i.e., in the absence of a control system dedicated to this function, maintaining a stable cooking bath temperature between 45° C. and 65° C. (about 115° F. and 150° F.) is very difficult. When considering the variability of performances between the cooking plates, notably between brands, models and technology (gas, induction, halogen) and the significant number of parameters to be taken into account (the physical phenomenon of convection or conduction about and in the bath, evaporation, nature and thermal conductivity of the container, volume of the bath, etc.), maintaining the cooking bath temperature constant is almost impossible.

Technical solutions for controlling temperature in food preparation methods are also known in other fields than that of this disclosure. The teaching of such documents is not relevant in the field of this disclosure, i.e., low-temperature vacuum cooking.

In particular, U.S. Patent Publication No. 2009/206080 relates to universal lids, intended for different sizes of containers, so that they can efficiently cover at least two different containers that differ from one another with regard to the size of the container opening. This patent application mentions that the cover comprises one or more sensor component(s), for example, for measuring temperature, time, etc.

U.S. Patent Publication No. 2009/206080 contains no teaching relating to the field of the invention.

U.S. Pat. No. 7,214,914 discloses a method for operating a microwave oven in order to determine the correct cooking time for a food product placed inside the oven. It discloses a food package comprising a thermochromic element that changes color over a predetermined temperature range when placed in the microwave oven. Such food package is rotated inside the oven cavity and the color of the thermochromic element is checked as it rotates past an optoelectronic device or a detector capable of detecting the color change of the thermochromic element so that a plurality of signal pulses are generated, with values corresponding to the color of the element.

U.S. Pat. No. 7,214,914 is not compatible with the field of the invention for low-temperature vacuum cooking.

European Patent EP2116481 discloses a package for high-pressure processing of food products and a method for high-pressure processing of food products, both being able to easily determine whether or not the food contained in the package has been subjected to a high-pressure processing. It comprises a housing body intended for receiving the items to be processed at high pressure, and an irreversible pressure indicator placed on the housing body in a position making it possible to see it from the outside of the housing body and adapted to develop a color when pressurized.

European Patent EP2116481 relates to sterilization using a method consisting of subjecting a food product to high pressure and high temperature, which is the opposite of the object of the invention in the field of low-temperature vacuum cooking with no pasteurization or sterilization purposes.

French Patent Application FR 2 674 019 discloses a device consisting of a thermometer glued or heat-sealed on a polyethylene pouch, wherein a food product under vacuum has been placed. The thermometer consists of a glass tube sealed in a 15-cm long, 2-cm wide and 1-cm thick plastic housing. Eventually, the device can be immersed in a container containing water. On the other hand, as the thermometer is thus inserted into a plastic housing, it does not enable an accurate measurement of temperature unless the medium temperature is stable, as when indicating cold (assuming that the product has been stored long enough).

In addition, French Patent Application FR 2 674 019 relates to a processing that is the opposite of the object of this disclosure: it relates to the sterilization of a product for storage purposes, whereas, on the contrary, this disclosure relates to a method intended for the immediate consumption of a product cooked at too low a temperature to enable pasteurization.

Korean Patent KR20080000253 discloses a package comprising a hologram making it possible to check that the cold chain has been respected.

These documents of the prior art are mentioned as mere information, although they do not belong to the field of the invention and mostly cause effects and results in contradiction with the aim of the present disclosure relating to low-temperature vacuum cooking with no sterilization or pasteurization purposes and for immediate consumption.

### BRIEF SUMMARY

An object of the present disclosure is to provide a device and a method for cooking a food product that remedy the shortcomings mentioned above.

In particular, the disclosure, in its broadest sense, relates to a low-temperature vacuum cooking method for immediate consumption without requiring sterilization or pasteurization.

This method makes it possible to apply a cooking mode requiring a perfect mastery of temperature, without using complex equipment with complicated thermo-regulating means. It makes it possible to apply sophisticated cooking modes with economic means, especially for home or small-scale implementation.

This disclosure also relates to a food cooking device comprising an envelope so configured as to contain the food product under vacuum and at least one thermochromic indicator in contact with the envelope.

A thermochromic indicator may comprise an indicator, such as a cooking and/or control indicator, comprising a material having the ability to change color and/or appearance according to temperature. Advantageously, the described device enables a simple and reliable control of the cooking temperature of food products. Advantageously, the described device enables low-temperature vacuum cooking, commonly referred to as “perfect-temperature cooking,” at home or in any environment without any specific equipment dedicated to such use, especially relating to the heat source used, which may be any domestic source (gas, electricity (e.g., induction, halogen), etc.) able to heat a pan or any other sealed and heat-resistant container.

According to one or more embodiment(s) of the first aspect, the thermochromic indicator is so configured as to change color and/or appearance when at least a preset temperature is reached.

According to one or more embodiment(s), the at least one thermochromic indicator comprises at least one first thermochromic indicator configured to change color and/or appearance at a first predetermined temperature. According to one or more embodiment(s), the first predetermined temperature is a target temperature for cooking the food product. For example, the target cooking temperature can range from 45° C. to 65° C. (about 115° F. to 150° F.).

According to one or more embodiment(s), the at least one thermochromic indicator comprises at least a second thermochromic indicator. For example, the at least one second thermochromic indicator can be configured to enable the user to control the temperature rise rate during the cooking of the food product and to modulate heating so as to prevent target temperature from being exceeded or inhomogeneous temperature in the food product.

According to one or more embodiment(s), the at least one second thermochromic indicator is configured to change color and/or appearance at a second predetermined temperature. For example, the second predetermined temperature is a control temperature between a cooking start temperature and the cooking target temperature.

According to one or more embodiment(s), the cooking start temperature corresponds to the temperature of domestic tap water. For example, the temperature of the domestic tap water may range from 1° C. to 30° C. (about 34° F. to 86° F.) and preferably from 3° C. to 15° C. (about 40° F. to 60° F.). For example, the control temperature may range from 30° C. to 45° C. (about 85° F. to 115° F.).

According to one or more embodiment(s), the envelope comprises a food-grade vacuum cooking pouch. According to one or more embodiment(s), the envelope is so configured as to support at least a target cooking temperature of the food product.

According to one or more embodiment(s), the envelope comprises a heat-sealable material and/or barrier material and/or a food-grade plastic material. In one or more embodiment(s), the plastic material comprises polyethylene and/or polyamide. According to one or more embodiment(s), the envelope comprises a flexible pouch configured for the preservation under vacuum of the food product.

According to one or more embodiment(s), the at least one thermochromic indicator comprises thermochromic liquid crystals or microcapsules encapsulating a thermochromic composition. For example, the thermochromic liquid crystals can be configured to change color by changing between a crystalline phase, a mesophase and an isotropic liquid phase as the temperature increases. For example, the microcapsules can be configured to encapsulate a composition comprising a plurality of components comprising at least a leuco dye (e.g., spirolactone, fluorans, spirospyranes, fulgide, etc.), at least one weak acid, and at least one solvent. For example, the leuco dye can change color according to the pH of the medium, the weak acid can act as a proton donor, and the solvent may be a polar solvent such as comprising an alcohol and/or an ester, for example.

According to one or more embodiment(s), the at least one thermochromic indicator is a reversible thermochromic indicator. According to one or more embodiment(s), the at least one thermochromic indicator comprises a reversible or non-reversible thermochromic indicator, with a phase change at a positive temperature.

According to one or more embodiment(s), the at least one thermochromic indicator is configured to be affected by the temperature at the interface between the food product and the envelope. According to one or more embodiment(s), the at least one thermochromic indicator is placed at the interface between the food product and the envelope. For example, the at least one thermochromic indicator may be placed on a portion of the inner surface of the envelope placed on a portion of the outer surface of the envelope, or confined in a thickness of the envelope.

According to one or more embodiment(s), the at least one thermochromic indicator is in contact with the envelope by gluing, printing, heat sealing or any other method for positioning the thermochromic indicator.

According to a second aspect, this disclosure relates to a method for cooking a food product, with such method comprising: placing a food product under vacuum in a device according to any one of the embodiments described above, and increasing the temperature of the device until the at least one thermochromic indicator changes color and/or appearance. For example, the at least one thermochromic indicator may change color and/or appearance at a first predetermined temperature.

Thus, for example, the method may further comprise providing a heat source configured to raise the temperature of the device. For example, the device may be placed in, on or near a cooking element (i.e., an element configured to increase the device temperature). For example, the device may be placed in a liquid bath, such as a sealed container containing cold water (i.e., domestic tap water), with the liquid bath being arranged on a cooking appliance. For example, the method may comprise the positioning of the device in a cold water bath and slowly increasing the bath temperature.

According to one or more embodiment(s), the method comprises the stopping of the increase in the device temperature when the at least one thermochromic indicator changes color and/or appearance.

According to one or more embodiment(s), the method includes the stopping of the heat source when the at least one thermochromic indicator changes color and/or appearance.

According to one or more embodiment(s), the method comprises allowing the device to rest in, on or near the cooking element, for example, in the liquid bath for a predetermined time, for example, for 5 minutes to 10 minutes, depending on the type of food product to be cooked and/or the desired type of cooking. According to one or more embodiment(s), the method comprises removing the device from the cooking element when the at least one thermochromic indicator changes color and/or appearance, when the increase in the temperature of the device is stopped, and/or when the heat source is stopped.

According to one or more embodiment(s), the at least one thermochromic indicator may comprise at least a second thermochromic indicator, which can be configured to control the food product temperature rise rate during the cooking of the food product. According to one or more embodiment(s), when the at least one second thermochromic indicator changes color or appearance during a time between a first predetermined time and a second predetermined time for the increase in the device temperature, the increase in the device temperature is maintained constant until the first thermochromic indicator changes color and/or appearance at the target cooking temperature of the food product.

According to one or more embodiment(s), if the at least one second thermochromic indicator has changed color or appearance in a shorter time than a first predetermined time for the increase in the device temperature, the increase in the device temperature is reduced until the at least one first thermochromic indicator changes color and/or appearance at the target cooking temperature of the food product.

According to one or more embodiment(s), if the at least one second thermochromic indicator has not changed color or appearance in a longer time than a second predetermined time for the increase in the device temperature, the increase in the device temperature is enhanced until the at least one first thermochromic indicator changes color and/or appearance at the target cooking temperature of the food product.

### BRIEF DESCRIPTION OF THE DRAWINGS

FIG. 1 schematically shows a food product cooking device, according to one embodiment of this disclosure.

### DETAILED DESCRIPTION

According to a first aspect, the present description relates to a food product cooking device comprising one or more indicator(s), for example, one or more cooking indicator(s) and/or one or more control indicator(s).

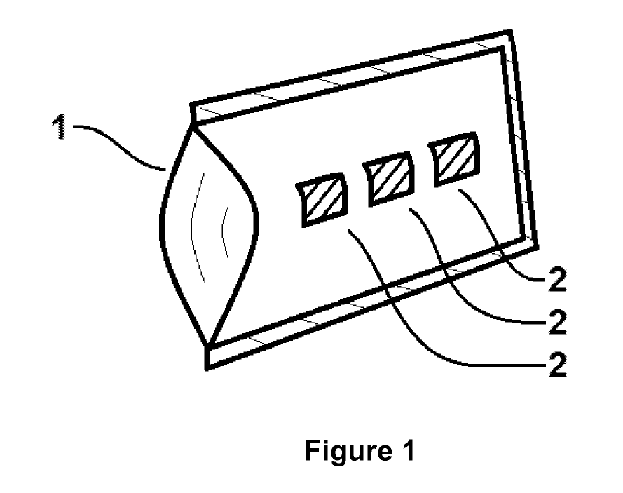

According to one or more embodiment(s) as shown in FIG. 1, the device comprises an envelope 1 configured to contain a food product under vacuum and at least one thermochromic indicator 2 in contact with the envelope 1. In the embodiment shown in FIG. 1, the at least one thermochromic indicator comprises three thermochromic indicators, all indicated by reference number 2, placed on a portion of an outer surface of the envelope. However, in other embodiments, the at least one thermochromic indicator may comprise a different number of thermochromic indicators and/or a different arrangement thereof, for example, on another portion of the outer surface of the envelope or on a portion of the inner surface of the envelope, or in the thickness of the envelope.

According to one or more embodiment(s), the at least one thermochromic indicator 2 comprises at least one first thermochromic indicator (i.e., a cooking indicator) configured to change color and/or appearance at a predetermined temperature, for example, the target cooking temperature of the food product (e.g., 58° C. (about 136.4° F.) for a semi-cooked salmon). Thus, the at least one first thermochromic indicator is configured to indicate when the heat input must stop. According to one or more embodiment(s), one or more additional cooking indicator(s) is/are in contact with the envelope 1, for example, to indicate the different doneness of the food product (rare, semi-cooked, cooked, etc.). The user can thus choose the doneness of the food product.

The device according to this disclosure is based on a kinematic different from the conventional techniques. As a matter of fact, the device is configured to enable the food product to be placed in, or on, or near a cooking element, like immersed in a cold bath and/or placed in an oven at ambient temperature (e.g., at a temperature below 30° C. (about 85° F.)), and gradually heated to reach a target cooking temperature. For example, the temperature of the cold bath when cooking is started may be that of domestic tap water and needs no strict control.

The food product is introduced into the envelope, which fulfills three functions. First, it prevents the food product from contacting the heating bath in order to avoid diluting the aromas and, more generally, any alteration of the food product. Second, it ensures the preservation of all the juices and aromas that are thus confined in the enclosure defined by the sealed envelope. Third, when the envelope is pressed against the surface of the food product, it ensures the transmission of heat by conduction, while avoiding the formation of air pockets that would alter the heat transfer and, therefore, the homogeneity of the low-temperature heating. As a matter of fact, at the considered temperatures, the heat transfer by convection is not effective.

The envelope can be pressed against the food product by placing it under a vacuum after introducing the product into the envelope. This placing under vacuum may be achieved by a device provided with a suction pump and a sealing, for example, a welding system. It can also be achieved by hand by immersing the filled envelope in a vessel containing water, in order to remove the air contained in the envelope, which is then sealed to prevent air from entering again.

It may also be achieved by using an elastic material. In this case, the envelope is elastically deformed during the insertion of the food product, then is naturally pressed against the food product.

The device may also consist of a pouch made of a heat-shrinkable material, having a valve enabling the expulsion of air when heating is started.

It may also consist of a stretch film enabling the tight wrapping of the food product before it is immersed in the heating bath.

The device according to this disclosure advantageously makes it possible to control the food product's temperature rise rate. For example, the device containing a food product may be placed in a cold water bath and slowly increased in temperature by means of a preferably low heat input to a cooking device. In other words, the device enables an increase in the food temperature, with a tolerance compatible with the requirements of temperature perfect cooking.

Conversely, the devices of the prior art, such as circulators, are configured to immerse the food product to be cooked in a water bath maintained at a target cooking temperature and then to wait for the food product to reach the same temperature as that of the water bath.

A method for using the device according to this disclosure can advantageously be executed using simple instructions such as the arrangement of the device in, on or near a cooking element. For example, the cooking element can be configured to increase the temperature of the device for a predetermined time or time range, for example, at a low power level (e.g., a water-filled sealed container placed on a heating plate with the thermostat being set on 2). The predetermined time or time range corresponds to the time or time range required to reach a predetermined temperature, such as a target cooking temperature, of the device and of the vacuum food product placed in the device. When the target cooking temperature is reached, the increase in temperature can be stopped, for example, by stopping the heat input into the cooking element. Depending on the type of the food product, the desired type of cooking and/or the type of cooking element used, the device can then be removed from the cooking element or left by the cooking element for a predetermined cooking end time.

On the contrary, when considering the variability existing between the powers of the household appliances, the calibration of the thermostats of domestic appliances, and the volumes and physical qualities of the food products to be cooked, specifically the thermal conductivity thereof, the low-temperature cooking kinematics traditionally used (e.g., introduction of a cold food product into a water bath maintained at a target temperature) require the use of extremely accurate mechanisms regulating the heat input. For example, using a thermometer for determining the temperature of a cooking medium requires a difficult calibration of the heat input and an extended stabilization of the medium temperature.

According to one or more embodiment(s), at least one thermochromic indicator 2 comprises at least a second thermochromic indicator (i.e., a control indicator configured to change color and/or appearance at one or more intermediate temperature(s), i.e., at least a lower temperature than the target cooking temperature and a higher temperature than the cooking start temperature.

The at least one second thermochromic indicator advantageously makes it possible to determine a temperature rise rate and thus to adjust the power of the heat source if the temperature rise rate is considered too fast or too slow. In other words, the device is advantageously configured to enable the control of the power of the heat source, so that a slow and steady increase in temperature ensures greater uniformity in the temperature of the food product. For example, depending on the temperature at which the control indicator changes color and/or appearance, the method for using the device according to this disclosure can provide for a predetermined time or time range (for example, between 10 minutes and 13 minutes after the start of cooking), during which the indicator is assumed to change color or appearance if the power of the heat source is appropriate. Thus, if the change is faster than the predetermined time or time range, the power of the heat source can be lowered. Similarly, if no change is observed after the predetermined time or time range has elapsed, the power of the heat source can be increased. Thus, the device makes it possible to even more accurately control the heat input during the increase in temperature of the device and thus prevent too fast a rise in temperature, which could lead to temperature disparity within the food product and to imperfect cooking.

The heating method consists, from a bath at a low initial temperature, for instance, the room temperature or the “tap water” temperature, in introducing the device containing the food product into the bath at such initial low temperature, and then in gradually heating the bath using any known means, for example, over a stove or using an electric immersion heater.

The user then has no accurate information for estimating the time required to reach the target temperature; more specifically, users rarely have temperature control means, let alone sufficiently precise thermoregulation means. To control the heating power, the thermochromic indicators provide the user with information that is precise, within one degree, and easy to interpret, so that he/she can thus easily act on the heating means to adjust the bath heating power.

If the device has intermediate indicators, the user will be informed of the need to lower the heating power if the change of state occurs too quickly with respect to the time recommended in the instructions. If, on the contrary, the change of state of an intermediate indicator is delayed, the user will know that the heat power has to be increased.

Eventually, the user knows precisely when heating should be stopped, when observing the change of state of the target temperature indicator.

The disclosure thus enables a user, who is not a professional or a craftsman, having only basic household appliances, to implement an elaborate cooking method requiring great precision, previously reserved for professionals.

Although it does not require using a heat source control means for stabilizing a target cooking temperature, the device of this disclosure advantageously makes it possible to provide a precision compatible with the requirements of perfect-temperature cooking by a simple visual control of the cooking of a food product. In addition, the device is particularly economical and enables a wide diffusion of a cooking mode hitherto requiring specific, bulky and expensive equipment. As a matter of fact, the accuracy achieved in the control of the cooking of a food product by determining a target cooking temperature and, optionally, a control temperature, is perfectly satisfactory.

As demonstrated below, the determination of a target cooking temperature using at least one thermochromic indicator 2, such as a cooking indicator, is sufficient information to regulate the heat input and to determine when the heat input must be stopped according to the desired doneness of the food product.

Two exemplary embodiments of the disclosure are as follows. 360 g of fresh salmon are placed under vacuum as two 180 g thick cut steaks.

The first steak is packaged in a first exemplary device according to this disclosure, comprising the following thermochromic indicators 2:
cooking indicators selected as follows:
   47° C. (about 117° F.): undercooked salmon like “sushi,”
   49° C. (about 120° F.): semi-cooked salmon,
   54° C. (about 129° F.): cooked salmon, and
   60° C. (about 140° F.): well-done salmon.

The first exemplary device according to this disclosure is immersed in a bath of 2 liters of tap water, for example, having a temperature of 10° C. (about 50° F.) in a stainless steel saucepan. Heating is initially set to 25% of the power of the heating device.

Depending on the desired doneness, the heat input is then stopped when the cooking indicator corresponding to the desired doneness changes color. In this example, the heat input is stopped as soon as the cooking indicator configured to change color at 49° C. (about 120° F.) changes color. In this example, the first device is then allowed to rest in the water bath for 5 minutes to ensure the homogenization of the temperature within the food product. Perfect-temperature cooking of semi-cooked salmon is thus reached.

The second steak is packaged in a second exemplary device according to this disclosure comprising the following thermochromic indicators 2:
a control indicator changing color at 40° C. (about 104° F.), and
a cooking indicator changing color at:
   47° C. (about 117° F.): rare salmon like “sushi.”

The second exemplary device according to this disclosure is immersed in a bath of 2 liters of tap water, for example, having a temperature of 10° C. (about 50° F.) in a stainless steel saucepan. Heating is initially set to 25% of the power of the heating device.

If the control indicator changes color or appearance between 10 minutes and 13 minutes, the 25% power is considered as appropriate. The power of the heating device is then kept constant.

If the control indicator changes color or appearance within 10 minutes, the 25% power is considered as too high. The power of the heating device is then reduced.

If the control indicator does not change color or appearance after 13 minutes, the 25% power is considered as too low. The power of the heating device is then increased.

In other words, reaching the color or appearance indicating a change in temperature of the control indicator within the predetermined time of 10 minutes indicates an excessive heat input and the need to reduce the heat input. On the contrary, not reaching the color or appearance indicating a change in temperature of the control indicator within 13 minutes indicates the need to increase the heat input. The control indicator then makes it possible to control the temperature rise rate of the food product during the cooking thereof.

Depending on the desired doneness, the heat input is then stopped when the cooking indicator corresponding to the desired doneness is reached. In this example, the heat input is stopped as soon as the cooking indicator configured to change color at 47° C. (about 117° F.) changes color. In this example, the second device is then allowed to rest in the water bath for 5 minutes to ensure the homogenization of temperature in the food product. Perfect-temperature cooking of rare salmon like “sushi” is thus reached.

The cooking obtained with a device according to this disclosure is advantageously similar to the one obtained with bulky, expensive, energy-intensive appliances specifically dedicated to perfect-temperature cooking. In other words, when using such a device of this disclosure, perfect-temperature cooking is accessible to all and can at last be reproduced perfectly and identically in a repeatable and reliable way.

The thermochromic indicators 2 can be produced in large series. Similarly, envelopes 1 so configured as to contain a food product under vacuum can also be produced in large series. The printing, welding or bonding of thermochromic indicators 2 can also be provided without any difficulty from an industrial point of view and inks formulated for this purpose already exist. Thus, the device according to this disclosure can easily be industrially produced.

Although described through a number of detailed exemplary embodiments, the device and method described in this disclosure include various alternative solutions, modifications and improvements that will become apparent to the persons skilled in the art, it being understood that such alternative solutions, modifications and improvements remain within the scope of the invention as defined by the following claims.

1. A method for cooking a food product under vacuum at low temperature, the method comprising placing a food product under vacuum in a sealed device and heating the product placed in the sealed device by submerging it in a bath to reach a target temperature of between 45° C. and 65° C., wherein the sealed device comprises at least one thermochromic indicator configured to change color and/or appearance at the target temperature, and wherein the temperature of the bath is gradually raised from an initial temperature of at least 20° C. below the target temperature.

2. The method for cooking a food product according to claim 1, wherein the heat input is controlled according to the color change of the at least one thermochromic indicator.

3. The method for cooking a food product according to claim 2, wherein the method further comprises allowing the food-containing device to rest in the water bath to equalize temperature within the food product.

4. The method for cooking a food product according to claim 1, wherein the initial temperature corresponds to the temperature of domestic tap water.

5. The method for cooking a food product according to claim 1, further comprising placing the food-containing device under vacuum prior to the introduction thereof into the bath.

6. The method for cooking a food product according to claim 1, wherein the sealed device further comprises at least a second thermochromic indicator configured to change color and/or appearance at a control temperature between the initial temperature and the cooking target temperature and to control the food product temperature rise rate during the cooking of the food product.

7. A device for cooking a food product under vacuum at low temperature, the device comprising an envelope configured to contain the food product and further comprising a first thermochromic indicator configured to change color and/or appearance at a predetermined target temperature, wherein the first thermochromic indicator is configured to change color and/or appearance at a temperature between 45° C. and 65° C.

8. The device according to claim 7, wherein the at least one thermochromic indicator is configured to change color and/or appearance at at least one target temperature selected from the group consisting of 47° C., 49° C., 54° C. and 60° C.

9. The device according to claim 8, wherein the device further comprises at least a second thermochromic indicator configured to change color and/or appearance at a control temperature between a cooking start temperature and the cooking target temperature and to control the food product temperature rise rate during the cooking of the food product.

10. The device according to claim 9, wherein the envelope is a flexible pouch configured for the preservation under vacuum of the food product.

11. The device according to claim 10, wherein the envelope comprises a heat-sealable material, a barrier material and/or a food grade plastic material.

12. The device according to claim 11, wherein the at least one thermochromic indicator comprises thermochromic liquid crystals or microcapsules encapsulating a thermochromic composition.

13. The device according to claim 12, wherein the at least one thermochromic indicator is a reversible thermochromic indicator.

14. The device according to claim 7, wherein the device further comprises at least a second thermochromic indicator configured to change color and/or appearance at a control temperature between a cooking start temperature and the cooking target temperature and to control the food product temperature rise rate during the cooking of the food product.

15. The device according to claim 7, wherein the envelope is a flexible pouch configured for the preservation under vacuum of the food product.

16. The device according to claim 7, wherein the envelope comprises a heat-sealable material, a barrier material and/or a food grade plastic material.

17. The device according to claim 7, wherein the at least one thermochromic indicator comprises thermochromic liquid crystals or microcapsules encapsulating a thermochromic composition.

18. The device according to claim 7, wherein the at least one thermochromic indicator is a reversible thermochromic indicator.

19. The method for cooking a food product according to claim 1, wherein the method further comprises allowing the food-containing device to rest in the water bath to equalize temperature within the food product.
